(19) United States
(12) Patent Application Publication
(10) Pub. No.: US 2025/0291765 A1
(43) Pub. Date: Sep. 18, 2025

(54) USING A STORAGE DRIVER TO CUSTOMIZE EDGE OPERATING SYSTEMS

(71) Applicant: Red Hat, Inc., Raleigh, NC (US)

(72) Inventors: Pierre-Yves Chibon, Puteaux (FR); Leigh Griffin, Waterford (IE)

(21) Appl. No.: 18/607,044

(22) Filed: Mar. 15, 2024

(51) Int. Cl. G06F 16/11; H04L 67/1097

(52) U.S. Cl. CPC G06F 16/128; H04L 67/1097

(57) ABSTRACT

Techniques for customizing the functionality of an operating system that is common to all devices in a network with specific application functionality are provided. A base image defining functionality that is common to a plurality of devices is provided. An application required by a first device of the plurality of devices is provided as a set of layers. The base image is provided to a first device and each of the set of layers are provided to the first device separately from the base image. At the first device, the set of layers is mounted on the base image.

### TECHNICAL FIELD

Aspects of the present disclosure relate to deploying applications on edge operating systems, and more particularly, using a storage driver to deploy applications provided as individual layers on edge operating systems.

### BACKGROUND

A mesh network is a network in which devices—or nodes—are linked together, branching off other devices or nodes. These networks are set up to efficiently route data between devices and clients. They help organizations provide a consistent connection throughout a physical space.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system, in accordance with some embodiments of the present disclosure.

FIG. 2 is a block diagram that illustrates the layers of a base image defining operating system and other functionality that is common to all devices in a network, in accordance with some embodiments of the present disclosure.

FIG. 3 is a block diagram that illustrates the system of FIG. 1 where applications that are unique to a computing device or subset of computing devices in a network are provided as one or more image files (layers), in accordance with some embodiments of the present disclosure.

FIG. 4 is a block diagram that illustrates the system of FIG. 3, during performance of an update of an application that is unique to a computing device or subset of computing devices of the network, in accordance with some embodiments of the present disclosure.

FIG. 5 is a flow diagram of a method for providing applications that are unique to a subset of computing devices in a network as one or more image files (layers) which can be retrieved and used by the subset of computing devices to customize the functionality of an operating system that is common to all devices in the network, in accordance with some embodiments of the present disclosure.

FIG. 6 is a block diagram of an example computing device that may perform one or more of the operations described herein, in accordance with some embodiments of the present disclosure.

### DETAILED DESCRIPTION

An edge device is a device that provides an entry point into enterprise or service provider core networks. Examples of edge devices include assembly line tools, IoT gateways, points of sale, and industrial controllers. A mesh network can have a diversity of edge devices that share a common operating system customized for the specific application of that device. There are many ways that this customization can be accomplished, from leveraging an automation controller such as Ansible to building a custom operating system using e.g., OSbuild. However, automation controllers are challenging to use when the device uses an immutable operating system (for example based on OSTree) and building a collection of mostly similar yet never quite the same operating system images can easily lead to the wrong image being put on a device.

The present disclosure addresses the above-noted and other deficiencies by providing applications that are unique to a computing device or subset of computing devices in a network as one or more application image files (also referred to herein as application layers). Operating system and other functionality which is common to all computing devices in the network are also provided as a base image file (also referred to herein as a base image) having one or more base layers (each base layer being an image file itself). The base image is provided to all computing devices in the network. The one or more application layers corresponding to the applications are provided to the computing device or each of the subset of computing devices individually. A storage driver provided as part of the functionality of the base image may be used to mount the one or more application layers on top of the base image. In this way, the computing device (or each of the subset of computing devices) in the network may customize the operating system functionality provided by the base image with the application functionality in an ad hoc manner, using application layers that are lightweight and easy to share (as opposed to a larger image file that has both application and operating system/common functionality). The immutable aspect of an image file means that the applications are always either fully installed or not at all, there is no between state as can happen when using e.g., RPM packages to install such applications.

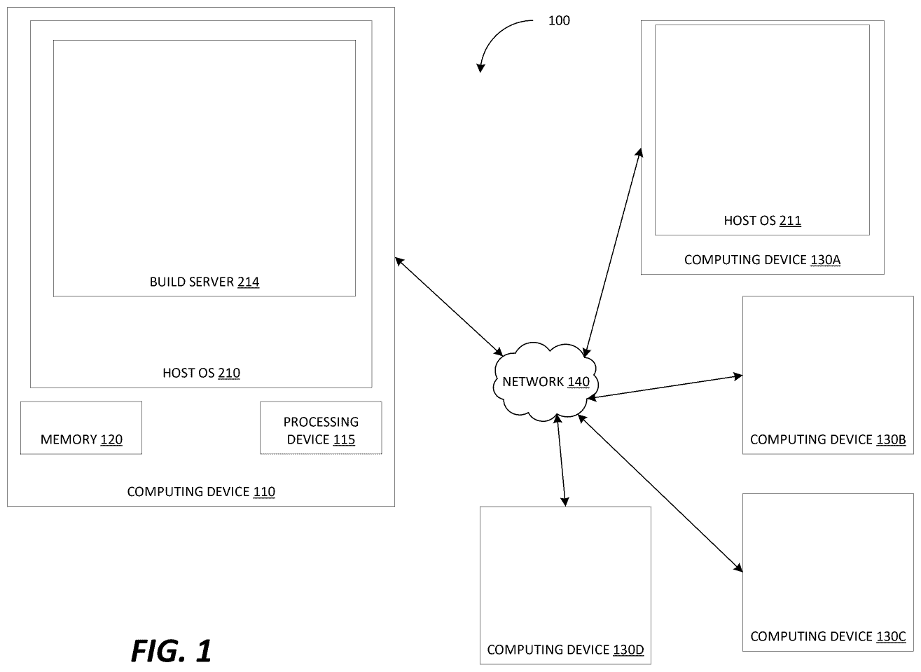

FIG. 1 is a block diagram that illustrates an example system 100. As illustrated in FIG. 1, the system 100 includes a computing device 110, and a plurality of computing devices 130. The computing devices 110 and 130 may be coupled to each other (e.g., may be operatively coupled, communicatively coupled, may communicate data/messages with each other) via network 140. Network 140 may be a public network (e.g., the internet), a private network (e.g., a local area network (LAN) or wide area network (WAN)), or a combination thereof. In one embodiment, network 140 may include a wired or a wireless infrastructure, which may be provided by one or more wireless communications systems, such as a WiFi™ hotspot connected with the network 140 and/or a wireless carrier system that can be implemented using various data processing equipment, communication towers (e.g., cell towers), etc. In some embodiments, the network 140 may be an L3 network. The network 140 may carry communications (e.g., data, message, packets, frames, etc.) between computing device 110, image registry 150, and computing devices 130. Each computing device 110 and 130 may include hardware such as processing device 115 (e.g., processors, central processing units (CPUs), memory 120 (e.g., random access memory 120 (e.g., RAM), storage devices (e.g., hard-disk drive (HDD), solid-state drive (SSD), etc.), and other hardware devices (e.g., sound card, video card, etc.). In some embodiments, memory 120 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 120 may be configured for long-term storage of data and may retain data between power on/off cycles of the computing device 110.

Each computing device may comprise any suitable type of computing device or machine that has a programmable processor including, for example, server computers, desktop computers, laptop computers, tablet computers, smartphones, set-top boxes, etc. In some examples, each of the computing devices 110 and 130 may comprise a single machine or may include multiple interconnected machines (e.g., multiple servers configured in a cluster). The computing devices 110 and 130 may be implemented by a common entity/organization or may be implemented by different entities/organizations. For example, computing device 110 may be operated by a first company/corporation and one or more computing devices 130 may be operated by a second company/corporation. Each of computing device 110 and computing devices 130 may execute or include an operating system (OS) such as host OS 210 and host OS 211 of computing device 110 and 130A respectively, as discussed in more detail below. The host OS of a computing device 110 and 130 may manage the execution of other components (e.g., software, applications, etc.) and/or may manage access to the hardware (e.g., processors, memory, storage devices etc.) of the computing device.

In some embodiments, the system 100 may correspond to a mesh network including a plurality of edge devices (computing devices 130) that share a common operating system that can be customized with the specific application/functionality of each computing device 130 or subset of computing devices 130. For example, the system 100 may be a data storage and analysis platform and the computing device 130A may function as a database, the computing device 130B may function as a database front end, the computing device 130C may function as a load balancer, and the computing device 130D may function as a database proxy.

The computing device 110 may implement a build server 214 where image files (e.g., docker images) are stored. An image file may include one or more layers, where each layer is an image file itself. Certain layers of an image file may define a runtime environment as well as the packages and utilities necessary for applications to run and may comprise read-only layers that are never modified. For example, a first layer of an image file used by a computing device 130 may comprise a host OS (including e.g., the OS kernel as well as the relevant packages (not shown) of the host OS including any associated libraries, binary and/or source files etc.), on which applications may run. A second layer may comprise a particular application to execute on a computing device 130 including any relevant packages and utilities necessary for the particular application to run. An image file may be shared by multiple computing devices 130. Although discussed as being stored within the build server 214, this is not a limitation and image files may also be stored in a separate image registry (not shown) which may be a registry server, for example.

The host OS of each computing device 130 may include a storage driver (not shown in FIG. 1), such as OverlayFS, to manage the contents of an image file including the read only and writable layers of the image file. The storage driver may be a type of union file system which allows a developer to overlay one file system (layer) on top of another. The storage driver may add a new writable (e.g., in-memory) layer on top of the underlying layers (the first and second layers) of the image file and changes may be recorded in the in-memory layer, while the underlying layer(s) remain unmodified. Changes made in the in-memory layer may be saved by creating a new layered image. In this way, multiple devices may share a single image file where the underlying layers are read-only media.

However, in a network of devices where subsets of devices may have similar operating system and other functionality requirements but different application requirements, building a collection of largely similar yet not quite the same image files can easily lead to the wrong image file being put on a device and would result in image files that are large (having to encompass operating system/other common functionality as well as specific application functionality) and difficult to share. Using an automation tool such as Ansible to retrieve and install one or more packages corresponding to an application on one or more computing devices 130 also has drawbacks. For example, there is no way to guarantee that the one or more packages were installed properly on each of the one or more computing devices 130. If a particular computing device 130 crashes during installation, some application files may be installed while others may not be, and/or application files may be installed but the associated scriptlets may not run etc.

Embodiments of the present disclosure may provide each application that is unique to a computing device 130 or subset of computing devices 130 (i.e., is not part of the operating system and any other functionality that is common to all computing devices 130) as one or more application image files (hereinafter application layers). Operating system and other functionality which is common to all computing devices 130 in the system 100 are also provided as a base image having one or more base layers (each base layer is an image file itself). Thus, the base image can be provided to all computing devices 130 while the one or more application layers may be provided to the computing device 130 or subset of computing devices 130 separately. A storage driver provided as part of the operating system functionality provided by the base image may mount each of the one or more application layers on top of the base image (i.e., “layer” each of the one or more application layers on top of the base image) to customize the operating system functionality in an ad hoc manner, as discussed in further detail herein. The immutable aspect of an image file means that when the one or more application layers are overlaid on the base image, the application(s) are either fully installed or not at all, there is no between state. By providing applications as layers that can be called when necessary and using the layers to build a custom image that encompasses the operating system and any other functionality that is common to all computing devices 130, as well as applications that are unique to the computing device 130 or the subset of computing devices 130, embodiments of the present disclosure provide an immutable aspect to the installation of such applications on the computing device 130 or the subset of computing devices 130.

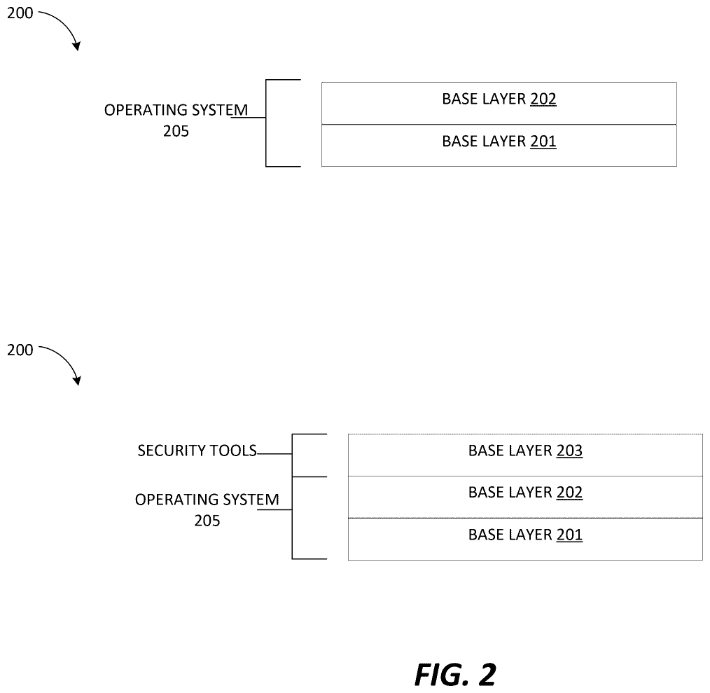

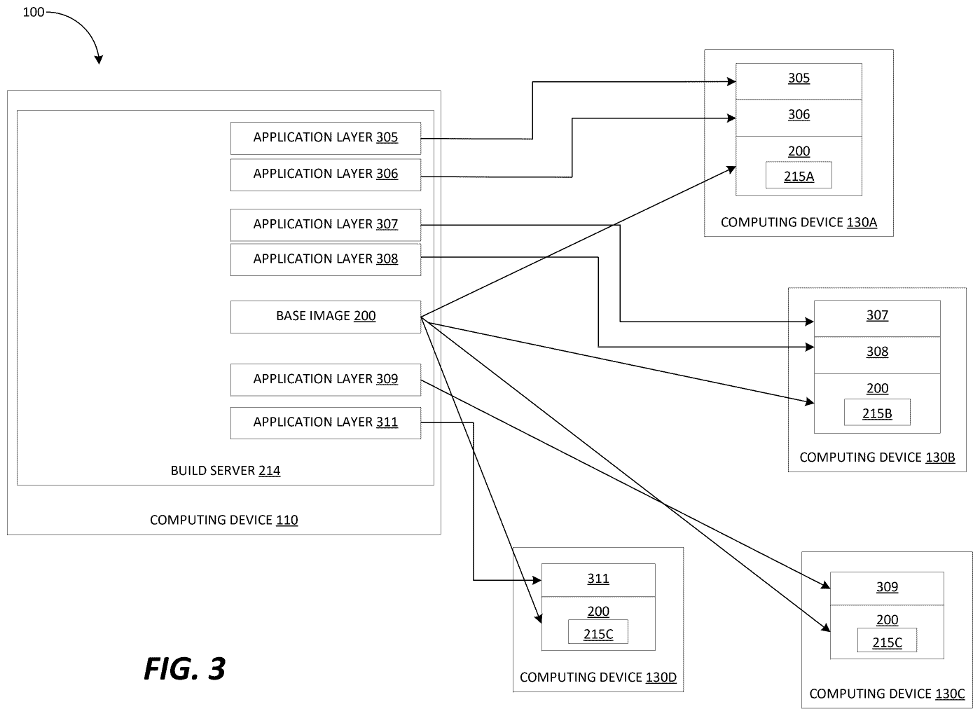

FIG. 2 illustrates an example base image 200 which may define an operating system (OS) 205 that is common to all computing devices 130. The base image 200 may include base layers 201 and 202, which define the OS 205 that is common to all of the computing devices 130 and include e.g., the OS kernel as well as the relevant packages (not shown) of the OS 205 including any associated libraries, binary and/or source files etc. The base layers 201 and 202 may also define storage driver functionality (shown as storage driver 215 in FIG. 3) and dependency analysis functionality as discussed in further detail herein. The base layers 201 and 202 may each comprise an image file themselves. The base image 200 may be shared by all of the computing devices 130. The base image 200 may not be limited to operating system functionality but may also include one or more base layers corresponding to other functionality that is common to all computing devices 130. For example, the system 100 may be a mesh network with heightened security requirements and thus may require certain security tools to be present across all computing devices 130. In such a scenario, the base image 200 may include a third base layer 203 which includes the required security tools as also shown in FIG. 2.

Referring now to FIG. 3, each computing device 130 may perform a specific function within the system 100 as discussed herein. The embodiments of the present disclosure are described using an example where the system 100 implements a data analysis and storage platform, with each computing device 130 performing a different function of the platform as discussed hereinabove. Thus, each computing device 130 may require the operating system 205 provided by the base image 200 to be customized with one or more unique applications corresponding to the specific function of the data analysis and storage platform they perform. By providing each of these applications as a layer(s), the functionality of the application may be realized in a lightweight manner that is easy to share and deploy. As shown in the example of FIG. 3, the build server 214 may include an application layer 305 which defines a database application and application layer 306 which defines logic/functionality that the database application depends on. The build server 214 may also include application layer 307 which defines a database front end application, and application layer 308 which defines logic/functionality that the database front end application depends on. The build server 214 may also include application layer 309 which defines a load balancer application, and application layer 311 which defines a database proxy application. It should be noted that each application is shown as defined by a single layer for ease of illustration and description. However, this is not a limitation, and each application may be defined using any appropriate number of layers.

The build server 214 may transmit the base image 200 to each computing device 130 so that the operating system 205 is installed on each computing device 130. The build server 214 may transmit the application layers 305 and 306 to the computing device 130A, where the local operating system 205 (not shown in FIG. 3) may install the application layers 305 and 306 and the local storage driver 215A may mount (i.e., overlay) application layers 305 and 306 on the base image 200. The build server 214 may transmit the application layers 307 and 308 to the computing device 130B, where the local operating system 205 may install the application layers 307 and 308 and the local storage driver 215B may mount application layers 307 and 308 on the base image 200. The build server 214 may transmit the application layer 309 to the computing device 130C, where the local operating system 205 may install the application layer 309 and the local storage driver 215C may mount the application layer 309 on the base image 200. The build server 214 may transmit the application layer 311 to the computing device 130D, where the local operating system 205 may install the application layer 311 the local storage driver 215D may mount the application layer 311 on the base image 200.

Each storage driver 215 may treat layered images like a graph of layers, with certain layers having dependencies on other layers. As a result, the local storage driver 215 of each computing device 130 requires information regarding a mount order for its respective application layers. The operating system 205 on each computing device 130 may perform a dependency analysis to determine the dependencies and mount order of the application layers it has installed using any well-known technique, and may provide the mount order information for the application layers to the local storage driver 215. For example, upon receiving the application layers 305 and 306, the local operating system 205 of the computing device 130A may analyze the dependencies and determine the mount order. Specifically, local operating system 205 of the computing device 130A may determine that application layer 306 should be mounted first and application layer 305 should be mounted second as it depends on application layer 306.

In some embodiments, a local operating system 205 may provide the mount order information as kernel parameters. Kernel parameters are tunable values which can be used to modify the behavior of the local operating system 205 and can be adjusted while the local operating system 205 is running. There is no requirement to reboot or recompile the kernel for changes to take effect. Providing the mount order information as kernel parameters of the local operating system 205 may provide additional security as such parameters can be signed by e.g., a kernel signing module of the local operating system 205 to authenticate them.

Once the local storage driver 215 of each computing device 130 has mounted the application layers installed thereon, each computing device 130 may be ready to begin executing its respective application(s). It should be noted that the examples discussed herein describe scenarios where each computing device 130 requires its own unique applications. However, this is not a limitation and subsets of computing devices 130 may require the same application functionality and thus may utilize the same application layers. For example, if both computing devices 130B and 130C are to function as database front ends, the build server 214 may transmit the application layers 307 and 308 to both computing devices 130B and 130C, where the local operating system 205 of each may install the application layers 307 and 308 and mount the application layers 307 and 308 on the base image 200.

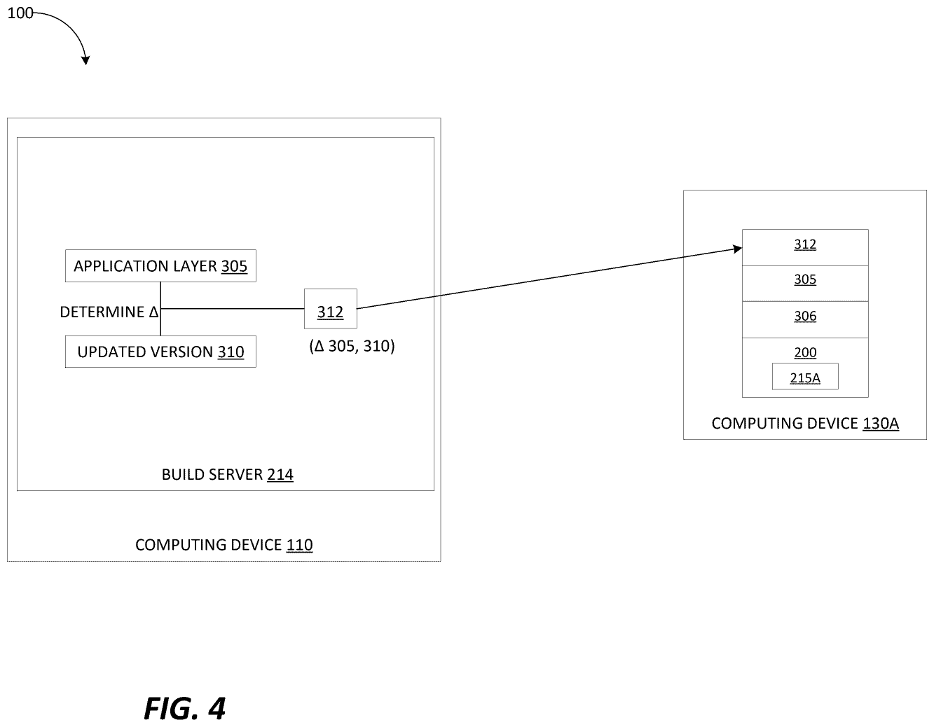

After each application layer is deployed on its respective computing device 130, the build server 214 may receive an update to application layer 305. Because each of the applications required by a particular computing device 130 are provided as individual layers, as are the OS 205 and any other functionality common to all computing devices 130, they can all be updated independently of each other. FIG. 4 illustrates the system 100 implementing a process for updating the database application defined by application layer 305.

As shown in FIG. 4, the build server 214 may receive an updated version 310 of the database application. The build server 214 may determine a difference between the application layer 305 and the updated version 310 and generate a new difference layer 312 that comprises the difference between the application layer 305 and the updated version 310. The build server 214 may send the difference layer 312 to the computing device 130A, where the local operating system 205 may install the difference layer 312, provide updated mount information to the local storage driver 215A and then mount (via local storage driver 215A) the difference layer 312 on top of the application layer 305. As discussed hereinabove, the immutable aspect of an image file means that the application/update is either fully installed or not at all, there is no between state. As a result, embodiments of the present disclosure provide an atomic update mechanism for the various unique applications that run on a system.

In some embodiments, instead of determining a difference between the application layer 305 and the updated version 310, the build server 214 may generate an update layer (not shown) that defines the updated version 310 (i.e., the updated version of the database application). The build server 214 may send the update layer to the computing device 130A where the local operating system 205 may install the update layer and, when convenient, the local operating system 205 (via the local storage driver 215A) can unmount application layer 305 and mount the update layer. This mount operation may act as an atomic update mechanism for the various unique applications that run on the system 100.

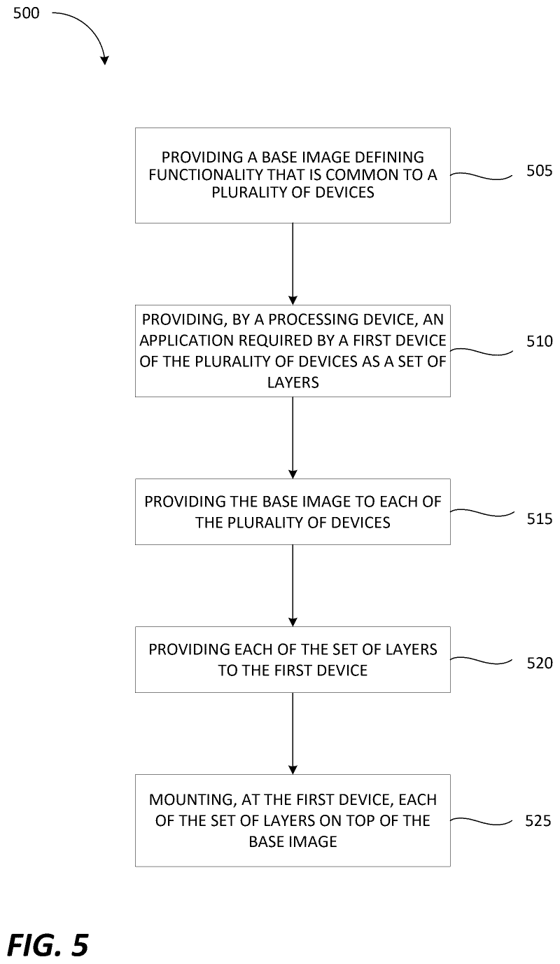

FIG. 5 is a flow diagram of a method 500 for providing applications that are unique to a computing device or subset of computing devices in a network as one or more image files (layers) which can be retrieved and used by the computing device (or subset of computing devices) in the network to customize (in an ad hoc manner) the functionality of an operating system that is common to all devices in the network, in accordance with some embodiments of the present disclosure. The method 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. in some embodiments, the method 500 may be performed by a computing device (e.g., computing device 110 illustrated in FIGS. 1-4).

Referring also to FIG. 3, at block 505 the build server 214 may provide base image 200 which may define an operating system (OS) 205 that is common to all computing devices 130. The base image 200 may not be limited to operating system functionality but may also include one or more base layers corresponding to other functionality that is common to all computing devices 130. For example, the system 100 may be a mesh network with heightened security requirements and thus may require certain security tools to be present across all computing devices 130. In such a scenario, the base image 200 may include a third base layer 203 which includes the required security tools as also shown in FIG. 2.

Each computing device 130 may perform a specific function within the system 100 as discussed herein and may thus require the operating system 205 provided by the base image 200 to be customized with one or more unique applications corresponding to the specific function of the data analysis and storage platform they perform. At block 510, the build server 214 may provide each of these applications as a layer(s) so that the functionality of the application may be realized in a lightweight manner that is easy to share and deploy. As shown in the example of FIG. 3, the build server 214 may include an application layer 305 which defines a database application and application layer 306 which defines logic/functionality that the database application depends on. The build server 214 may also include application layer 307 which defines a database front end application, and application layer 308 which defines logic/functionality that the database front end application depends on. The build server 214 may also include application layer 309 which defines a load balancer application, and application layer 311 which defines a database proxy application. It should be noted that each application is shown as defined by a single layer for ease of illustration and description. However, this is not a limitation, and each application may be defined using any appropriate number of layers.

At block 515 the build server 214 may transmit the base image 200 to each computing device 130 so that the operating system 205 is installed on each computing device 130. At block 520 the build server 214 may transmit the application layers 305 and 306 to the computing device 130A, where the local operating system 205 (not shown in FIG. 3) may install the application layers 305 and 306. The build server 214 may transmit the application layers 307 and 308 to the computing device 130B, where the local operating system 205 may install the application layers. The build server 214 may transmit the application layer 309 to the computing device 130C, where the local operating system 205 may install the application layer 309. The build server 214 may transmit the application layer 311 to the computing device 130D, where the local operating system 205 may install the application layer 311. At block 525, the local storage driver 215A may mount (i.e., overlay) application layers 305 and 306 on the local base image 200. The local storage driver 215B may mount application layers 307 and 308 on the local base image 200. The local storage driver 215C may mount the application layer 309 on the local base image 200 and the local storage driver 215D may mount the application layer 311 on the local base image 200.

Each storage driver 215 may treat layered images like a graph of layers, with certain layers having dependencies on other layers. As a result, the local storage driver 215 of each computing device 130 requires information regarding a mount order for its respective application layers. The operating system 205 on each computing device 130 may perform a dependency analysis to determine the dependencies and mount order of the application layers it has installed using any well-known technique, and may provide the mount order information for the application layers to the local storage driver 215. For example, upon receiving the application layers 305 and 306, the local operating system 205 of the computing device 130A may analyze the dependencies and determine the mount order. Specifically, local operating system 205 of the computing device 130A may determine that application layer 306 should be mounted first and application layer 305 should be mounted second as it depends on application layer 306.

In some embodiments, a local operating system 205 may provide the mount order information as kernel parameters. Kernel parameters are tunable values which can be used to modify the behavior of the local operating system 205 and can be adjusted while the local operating system 205 is running. There is no requirement to reboot or recompile the kernel for changes to take effect. Providing the mount order information as kernel parameters of the local operating system 205 may provide additional security as such parameters can be signed by e.g., a kernel signing module of the local operating system 205 to authenticate them.

Once the local storage driver 215 of each computing device 130 has mounted the application layers installed thereon, each computing device 130 may be ready to begin executing its respective application(s). It should be noted that the examples discussed herein describe scenarios where each computing device 130 requires its own unique applications.

After each application layer is deployed on its respective computing device 130, the build server 214 may receive an update to application layer 305. Because each of the applications required by a particular computing device 130 are provided as individual layers, as are the OS 205 and any other functionality common to all computing devices 130, they can all be updated independently of each other. FIG. 4 illustrates the system 100 implementing a process for updating the database application defined by application layer 305.

As shown in FIG. 4, the build server 214 may receive an updated version 310 of the database application. The build server 214 may determine a difference between the application layer 305 and the updated version 310 and generate a new difference layer 312 that comprises the difference between the application layer 305 and the updated version 310. The build server 214 may send the difference layer 312 to the computing device 130A, where the local operating system 205 may install the difference layer 312, provide updated mount information to the local storage driver 215A and then mount (via local storage driver 215A) the difference layer 312 on top of the application layer 305. As discussed hereinabove, the immutable aspect of an image file means that the application/update is either fully installed or not at all, there is no between state. As a result, embodiments of the present disclosure provide an atomic update mechanism for the various unique applications that run on a system.

In some embodiments, instead of determining a difference between the application layer 305 and the updated version 310, the build server 214 may generate an update layer (not shown) that defines the updated version 310 (i.e., the updated version of the database application). The build server 214 may send the update layer to the computing device 130A where the local operating system 205 may install the update layer and, when convenient, the local operating system 205 (via the local storage driver 215A) can unmount application layer 305 and mount the update layer. This mount operation may act as an atomic update mechanism for the various unique applications that run on the system 100.

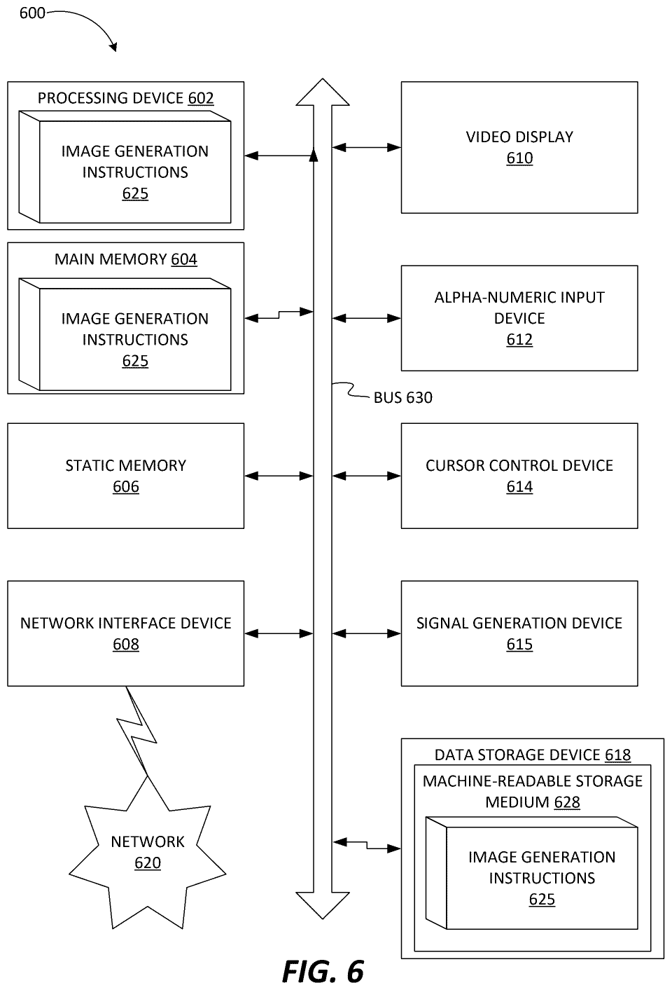

FIG. 6 illustrates a diagrammatic representation of a machine in the example form of a computer system 600 within which a set of instructions, for causing the machine to perform any one or more of the methodologies discussed herein for providing applications that are unique to a computing device or subset of computing devices in a network as one or more image files (layers) which can be retrieved and used by the computing device (or subset of computing devices) in the network to customize (in an ad hoc manner) the functionality of an operating system that is common to all devices in the network, in accordance with some embodiments of the present disclosure.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 600 may be representative of a server.

The exemplary computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 615 (e.g., a speaker). In one embodiment, video display unit 610, alphanumeric input device 612, and cursor control device 614 may be combined into a single component or device (e.g., an LCD touch screen).

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute image generation instructions 625, for performing the operations and steps discussed herein.

The data storage device 618 may include a machine-readable storage medium 628, on which is stored one or more sets of image generation instructions 625 (e.g., software) embodying any one or more of the methodologies of functions described herein. The image generation instructions 625 may also reside, completely or at least partially, within the main memory 604 or within the processing device 602 during execution thereof by the computer system 600; the main memory 604 and the processing device 602 also constituting machine-readable storage media. The image generation instructions 625 may further be transmitted or received over a network 620 via the network interface device 608.

The machine-readable storage medium 628 may also be used to store instructions to perform a method for providing applications that are unique to a computing device or subset of computing devices in a network as one or more image files (layers) which can be retrieved and used by the computing device (or subset of computing devices) in the network to customize (in an ad hoc manner) the functionality of an operating system that is common to all devices in the network, as described herein. While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “providing,” “mounting,” “receiving,” “calculating,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

1. A method comprising:
providing a base image defining functionality that is common to a plurality of devices;
providing, by a processing device, an application required by a first device of the plurality of devices as a set of layers that is separate from the base image;
providing the base image to each of the plurality of devices;
providing each of the set of layers to the first device; and
mounting, at the first device, each of the set of layers on top of the base image.

2. The method of claim 1, further comprising:
determining a mount order for each of the set of layers; and
providing the mount order to a storage driver of the first device, wherein the storage driver mounts each of the set of layers on top of the base image based on the mount order.

3. The method of claim 2, wherein the mount order is provided to the storage driver as kernel parameters of an operating system defined by the base image.

4. The method of claim 1, further comprising:
receiving an updated version of the first application;
calculating a difference between the first application and the updated version of the first application;
providing the difference to the first device as a new layer; and
mounting the new layer on top of the set of layers using a storage driver of an operating system defined by the base image.

5. The method of claim 1, further comprising:
receiving an updated version of the first application;
providing the updated version to the first device as a new set of layers;
unmounting the set of layers using a storage driver of an operating system defined by the base image; and
mounting the new set of layers using the storage driver.

6. The method of claim 1, wherein the functionality that is common to the plurality of devices comprises an operating system.

7. The method of claim 2, wherein the storage driver comprises an overlay file system.

8. A system comprising:
a memory; and
a processing device operatively coupled to the memory, the processing device to:
provide a base image defining functionality that is common to a plurality of devices;
provide an application required by a first device of the plurality of devices as a set of layers that is separate from the base image;
provide the base image to each of the plurality of devices;
provide each of the set of layers to the first device; and
mount, at the first device, each of the set of layers on top of the base image.

9. The system of claim 8, wherein the processing device is further to:
determine a mount order for each of the set of layers; and
provide the mount order to a storage driver of the first device, wherein the storage driver mounts each of the set of layers on top of the base image based on the mount order.

10. The system of claim 9, wherein the processing device provides the mount order to the storage driver as kernel parameters of an operating system defined by the base image.

11. The system of claim 8, wherein the processing device is further to:
receive an updated version of the first application;
calculate a difference between the first application and the updated version of the first application;
provide the difference to the first device as a new layer; and
mount the new layer on top of the set of layers using a storage driver of an operating system defined by the base image.

12. The system of claim 8, wherein the processing device is further to:
receive an updated version of the first application;
provide the updated version to the first device as a new set of layers;
unmount the set of layers using a storage driver of an operating system defined by the base image; and
mount the new set of layers using the storage driver.

13. The system of claim 8, wherein the functionality that is common to the plurality of devices comprises an operating system.

14. The system of claim 9, wherein the storage driver comprises an overlay file system.

15. A non-transitory computer-readable medium having instructions stored thereon which, when executed by a processing device, cause the processing device to:
provide a base image defining functionality that is common to a plurality of devices;
provide, by the processing device, an application required by a first device of the plurality of devices as a set of layers that is separate from the base image;
provide the base image to each of the plurality of devices;
provide each of the set of layers to the first device; and
mount, at the first device, each of the set of layers on top of the base image.

16. The non-transitory computer-readable medium of claim 15, wherein the processing device is further to:
determine a mount order for each of the set of layers; and
provide the mount order to a storage driver of the first device, wherein the storage driver mounts each of the set of layers on top of the base image based on the mount order.

17. The non-transitory computer-readable medium of claim 16, wherein the processing device provides the mount order to the storage driver as kernel parameters of an operating system defined by the base image.

18. The non-transitory computer-readable medium of claim 15, wherein the processing device is further to:
receive an updated version of the first application;
calculate a difference between the first application and the updated version of the first application;
provide the difference to the first device as a new layer; and
mount the new layer on top of the set of layers using a storage driver of an operating system defined by the base image.

19. The non-transitory computer-readable medium of claim 15, wherein the processing device is further to:
receive an updated version of the first application;
provide the updated version to the first device as a new set of layers;
unmount the set of layers using a storage driver of an operating system defined by the base image; and
mount the new set of layers using the storage driver.

20. The non-transitory computer-readable medium of claim 15, wherein the functionality that is common to the plurality of devices comprises an operating system.
